(19) United States
(12) Patent Application Publication
(10) Pub. No.: US 2015/0018082 A1
(43) Pub. Date: Jan. 15, 2015

(54) Method for Providing Predict Event Service of Match Result, Server Therefor, and Recording Media Therefor

(71) Applicant: Intellectual Discovery Co., Ltd., Seoul (KR)

(72) Inventor: Woon Yong Kim, Suwon-si (KR)

(73) Assignee: Intellectual Discovery Co., Ltd., Seoul (KR)

(21) Appl. No.: 14/368,922

(22) PCT Filed: Dec. 24, 2012
(86) PCT No.: PCT/KR2012/011411

§ 371 Date: Jun. 26, 2014

(30) Foreign Application Priority Data
Dec. 30, 2011 (KR) 10-2011-0147751

(51) Int. Cl. A63F 13/46; A63F 13/49; A63F 13/35

(52) U.S. Cl. CPC A63F 13/46; A63F 13/35; A63F 13/49
USPC 463/25

(57) ABSTRACT

A method for providing an event service of a match result prediction includes: a first step of generating the same online game as at least one actual match in a server; a second step of receiving a winning team prediction data of the actual match from a user operation of a client by the server; a third step of activating the window to predict and input at least one among the score and the first scorer of the actual match in the server when the user wins in the online game in accordance with the winning team prediction data; and a fourth step of inputting at least one of the score and the first scorer of the actual match to the server and executing a reward providing odds determined according to a winning probability of a team selected by the user when the result of the actual match is in accordance with one of the winning team prediction data, the score, and the first scorer.

### TECHNICAL FIELD

The present disclosure relates to a method for providing an event service of a match result prediction, a server therefor, and a recording media therefor. More particularly, the present disclosure relates to a method for providing an event service of a match result prediction providing realism such that the online game seems to be an actual match since a predicted team must win by the user's effort in the online game to predict a match result, a server therefor, and a recording media therefor.

### BACKGROUND ART

In general, an online game is a real-time game using an internet. The online game has grown rapidly by the development of the internet, and there are a multiple user dialogue (MUD) game and a multiple user graphics (MUG) game in which a program is installed to a hard disk drive and the user accesses the internet server to enjoy the game, a web-based game that may be played by only using a browser, and a mobile game using a mobile phone.

Thanks to the domestic high-speed Internet of the highest level in the world and the spread of mobile phones, the size of the game industry including online games and mobile games is larger by two times the combined movie and music market, it is trending to an increasingly larger scale, and it is also active abroad, as games are exported to the United States and Europe as well as China, Taiwan, Japan, and Southeast Asia, and it is evaluated as the world superpower of online games.

The online games taking place via the Internet are mainly going to be increasingly popular with the youth generation, and the user may download game programs provided on the web to the user's PC to execute the game or to execute the same one while online.

In a sports lottery, several persons predict a match result with each other with a small group while watching a football match and bet a small amount of money with each other such that interest in the football match may be increased.

A relatively large-sized lottery only allows wagers on the result points of the match such that several record numbers of interest and several expected results generated in the football match may not be included in a probability game, and it is impossible for a plurality of persons to participate, to continuously induce interest, to simply inform the result, and to transparently execute the match.

For this, the probability game causing the interest to allow the game to target a plurality of items that are variously predicted by linking the football match that is a person's day-to-day concern to a cyber-probability game to secure many members and to simultaneously provide the cyber points is disclosed in Korea Patent Publication No. 10-2000-0050039.

FIG. 1 is a schematic diagram illustrating a football game system and a method thereof according to a conventional art. Referring to FIG. 1, the method of predicting a result of a football game or predicting various results of a match discloses a process of searching a soccer lottery index (SBI) that is capable of being searched for a result predict index of a soccer match if paid and unpaid members are signed up, calculating a prediction index to be calculated by selecting a certain match, searching an expected watching evaluation capable of looking at an evaluation before the soccer play, accumulating cyber points, buying soccer fund coupons, and winning prizes by participating in the probability game and confirming the result.

However, when simply predicting the result of the soccer game and changing it into the probability game of the lottery type, the users who do not participate in the actual game inevitably just wait for the result, and the football games are regarded as gambling that is not just a game during the waiting such that the users do not enjoy the soccer game, but the game may be thought of as a target to feel pressured, and the users feel the fun while watching a world cup result prediction of a gambler or an octopus as a fortune-teller and enjoy the game of a lottery type such as a sports Toto, due to the absence of the item including the match result prediction as a content in the online game, the game considering the users that simply just wait for the result of the game is desperately required.

The above information disclosed in this Background section is only for enhancement of understanding of the background of the disclosure and therefore it may contain information that does not form the prior art that is already known in this country to a person of ordinary skill in the art.

### DISCLOSURE

### Technical Problem

The present disclosure provides a method of providing an event service of a match result prediction that maximizes fun of an actual game and an online game by making the same match teams as an actual match in an online game and participating in an event in a case that the users must win the match through the team that is directly selected by the user in the online game to predict their match result, thereby helping game participation of the users and together making the prediction result without only waiting on the prediction result, a server thereof, and a recording media thereof.

The present disclosure provides a method of providing an event service of a match result prediction by further concentrating on an online game due a factor like a player of a real game and feeling realism such as running the actual game in the virtual online game while linking of the online game and the actual match by inserting content for an actual match prediction in the online game, a server thereof, and a recording media thereof.

The present disclosure provides a method of providing an event service of a match result prediction maximizing an interest factor like the real game in the virtual online game by grafting the online game to the real game without encouraging gambling since the users participate in the event in the case that the team that is predicted to win by them in the game must win by their effort, rather than as a vague probability game like a gambling lottery, a server thereof, and a recording media thereof.

The present disclosure provides a method of providing an event service of a match result prediction creating a new revenue structure by deriving a purchase of the same item and increasing richness of the item with prediction assistance contents helping determining of the user by consuming a point, a game currency, and a cache item when participating in the event, a server thereof, and a recording media thereof.

The present disclosure provides a method of providing an event service of a match result prediction attracting the interest of the users who do have interest in the small competition and simultaneously acting as a means to promote the competition by deriving interest in the real game such as the K League, World Cup, and Asian Games, a server thereof, and a recording media thereof.

### Technical Solution

In exemplary embodiments to obtain these objects, the present disclosure provides a method for providing an event service of a match result prediction including: a first step of generating the same online game as at least one actual match in a server; a second step of receiving winning team prediction data of the actual match from a user operation of a client by the server; a third step of activating a window to predict and input at least one among a score and a first scorer of the actual match in the server when the user wins in the online game in accordance with the winning team prediction data; and a fourth step of inputting at least one of the score and the first scorer of the actual match to the server and executing a reward providing odds determined according to a winning probability of a team selected by the user when the result of the actual match is in accordance with one of the winning team prediction data, the score, and the first scorer.

In the exemplary embodiments, the present disclosure provides a method for providing an event service of a match result prediction including: a first step of generating the same online game as a league as an actual match of at least one group stage; a second step of receiving winning team prediction data of the actual match from a user operation of a client by the server; a third step of activating to predict and input at least one of a score of the actual match, the first scorer, and a league ranking; and a fourth step of executing a corresponding reward when the result of the actual match is in accordance with one of the winning team prediction data, the score, the first scorer, and the league ranking.

In the exemplary embodiments, the present disclosure provides a method for providing an event service of a match result prediction including: a first step of generating the same online game as at least one real tournament; a second step of receiving at least one piece of prediction data among N final lists of the actual tournament and a winning team from the user; and a third step of executing a corresponding reward when the user wins in an online team war environment in accordance with the prediction data and at least one of the prediction data is in accordance with the result of the actual match.

In an exemplary embodiment, for the third step, if the user executes control to change the winning team prediction data, the server is returned to the second step.

In an exemplary embodiment, for the third step, if the user executes control to change the data predicting at least one of the score and the first scorer of the actual match, the server activates the online game.

In an exemplary embodiment, for the third step, if the user executes control to change the data predicting at least one of the score, the first scorer, and the league ranking of the actual match, the server activates the online game.

In an exemplary embodiment, for the reward, odds are determined such that a reward is small if the selected team wins a lot and the reward is large if the selected team wins less.

In an exemplary embodiment, for the second step, the server provides a prediction event list that is ongoing, event information selected by the prediction of the user, and information related to the prediction event.

In an exemplary embodiment, the information related to the prediction event includes at least one of prediction data predicted by other users who participated in the event.

In an exemplary embodiment, it is possible for the user to change the prediction data before the actual match starts, before a first score after the actual game starts, before a first half after the actual game starts, or before a second half when there is extra time after the actual game starts.

In an exemplary embodiment, the data change is possible when 1% to 80% of the league has progress.

In an exemplary embodiment, for the third step, the prediction of the user is not input, and the result in the online game is in accordance with at least one of the score of the actual match, the first scorer, and the winning team prediction data.

In exemplary embodiments, a computer readable recording medium recorded with a program to execute a method for providing an event service of a match result prediction, wherein the method for providing the predict event service of the match result includes: a function of generating the same online game as at least one actual match in a server; a function of receiving winning team prediction data of the actual match from the user operation of a client through the server; a function of activating a window to predict and input at least one of the score of the actual match and the first scorer in the server when the user wins in accordance with the winning team prediction data in the online game; and a function of receiving at least one of the score of the actual match and the first scorer through the server and executing a reward providing odds determined according to a winning probability of the team selected by the user, wherein the result of the actual match is in accordance with at least one of the winning team prediction data, the score, and the first scorer.

In exemplary embodiments, a computer readable recording medium recorded with a program to execute a method for providing an event service of a match result prediction, wherein the method for providing the predict event service of the match result includes: a function of generating the same online game as a league as the actual match of at least one group stage; a function of receiving winning team prediction data of the actual match from a user operation of a client by the server; a function of activating to predict and input at least one of the score of the actual match, the first scorer, and a league ranking; and a function of executing a corresponding reward when the result of the actual match is in accordance with one of the winning team prediction data, the score, the first scorer, and the league ranking.

In exemplary embodiments, a computer readable recording medium recorded with a program to execute a method for providing an event service of a match result prediction, wherein the method for providing the predict event service of the match result includes: a function of generating the same online game as at least one real tournament; a function of receiving at least one piece of prediction data among N final lists of the actual tournament and a winning team from the user; and a function of executing a corresponding reward when the user wins in an online team war environment in accordance with the prediction data and at least one of the prediction data is in accordance with the result of the actual match.

In exemplary embodiments, a server providing an event service of a match result prediction includes: a communicator transmitting and receiving data; a controller respectively controlling constituent elements; a storing unit storing at least one of a winning team of at least one actual match, a ranking, N teams finalists, a winning team if the client inputs at least one of the winning team of at least one actual match, the ranking, the N teams finalists, and the winning team, and receiving and storing the score of the actual match of the user and a first scorer when the user operating the client wins in the online game; a prediction determination unit activating a window to input the score of the actual match and the first scorer when the user wins in the online game for the user operating the client to input the score of the actual match and the first scorer; an event management unit generating a window to input a game prediction data by the client, a user interface (UI) related to the game prediction data; and a controller controlling the communicator, the storing unit, the prediction determination unit, and the event management unit.

### Advantageous Effects

As described above, the disclosed technique of the present disclosure having the above configuration \textcircled{1} may maximize the fun of the actual game and the online game by making the same match team as an actual match in an online game and participating in an event in a case that the users must win the match through the team that is directly selected by the user in the online game to predict their match result, thereby helping game participation of the users and together making the prediction result without only waiting the prediction result, \textcircled{2} may further concentrate on the online game due the factor like the player of the real game and may feel realism such as running the actual game in the virtual online game while linking of the online game and the actual match by inserting the content for the actual match prediction in the online game, \textcircled{3} may maximize the interest factor like the real game in the virtual online game by grafting the online game to the real game without encouraging gambling since the users participate in the event in the case that the team that is predicted to win by them in the game must win by their effort, rather than as a vague probability game like a gambling lottery, \textcircled{4} may create a new revenue structure by deriving a purchase of the same item and may increase richness of the item with prediction assistance contents helping determining of the user by consuming a point, a game currency, a cache item when participating in the event, and \textcircled{5} may attract the interest of the users who do not have interest in the small competition and may simultaneously act as a means to promote the competition by deriving interest in the real game such as the K League, a World Cup, and Asian Games.

### DESCRIPTION OF THE DRAWINGS

FIG. 1 is a schematic diagram illustrating a soccer game system and a method thereof according to a conventional art.

FIG. 2 is a diagram of a system providing an event service of a match result prediction according to a technique disclosed in the present disclosure.

FIG. 3 is a block diagram of a server providing an event service of a match result prediction according to a technique disclosed in the present disclosure.

FIGS. 4A and 4B are block diagrams of a driving operation of a server providing an event service of a match result prediction according to a technique disclosed in the present disclosure.

FIG. 5 shows a main screen of an event service of a match result prediction according to a technique disclosed in the present disclosure.

FIGS. 6A, 6B, 6C, and 6D show screens of a progress process of an event service of a match result prediction according to a technique disclosed in the present disclosure.

FIGS. 7A, 7B, and 7C show an exemplary embodiment applied with an event service of a match result prediction according to a technique disclosed in the present disclosure.

FIG. 8 is a flowchart showing a method of providing an event service of a match result prediction according to a technique disclosed in the present disclosure.

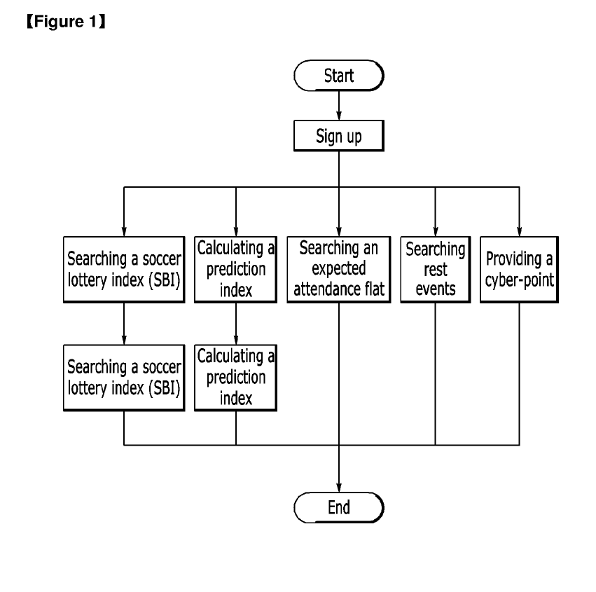

### MODE FOR INVENTION

Descriptions of the disclosed skill are exemplary embodiments for structural or functional descriptions, and the scope of the disclosed skill is not to be understood to be restricted by the exemplary embodiment described in the specification. That is, it is to be understood that the exemplary embodiment is intended to cover various modifications and equivalent arrangements included within the spirit and scope of the appended claims. Further, the proposed objects or effects in the disclosed technique do not signify that a specific exemplary embodiment may include all of them or include the effects, so the scope of the disclosed skill is not to be understood to be restricted by the exemplary embodiment described in the specification.

In addition, terms that are described in the present disclosure are to be understood as follows.

Terms such as “first,” “second,” etc., may be used to distinguish one constituent element from another constituent element, but the scope must not be restricted by the terms. For example, a first constituent element may be called a second constituent element, and similarly, the second constituent element may be called the first constituent element.

It is noted that when it is described that a certain constituent element is “connected” to another constituent element, they may be directly connected or electrically connected to each other, and a third constituent element may exist therebetween. On the contrary, it is also noted that when it is described that a certain constituent element is “directly connected” or “directly electrically connected” to another constituent element, a third constituent element does not exist therebetween. In addition, other expressions that describe relationships among constituent elements such as, “between,” “just between,” or “adjacent to” and “directly adjacent to” must be understood in a like manner.

An expression used in the singular encompasses an expression of the plural, unless it has a clearly different meaning in the context, and it is to be understood that terms such as “including,” “having,” etc. are intended to indicate the existence of features, numbers, steps, actions, components, parts, or combinations thereof disclosed in the specification, and are not intended to preclude the possibility that one or more other features, numbers, steps, actions, components, parts, or combinations thereof may exist or may be added.

Identification codes (e.g., a, b, c, etc.) in respective stages are used for better comprehension and ease of description, but they do not necessarily describe an order of the respective stages, and the respective stages may be performed in a different order from the described order unless a specific order is written in the context. That is, the respective stages may be performed according to the described order, they may be performed substantially simultaneously, and they may be performed in an opposite order.

The present disclosure can be implemented as a computer-readable code in a computer-readable recording medium, and the computer-readable recording medium includes all types of recording apparatuses in which data that can be read by a computer system is stored. Examples of the computer-readable recording media include a ROM, a RAM, a CD-ROM, a magnetic tape, a floppy disk, an optical data storage unit, a non-memory semiconductor, etc., and in addition, they include a recording medium implemented in the form of a carrier wave (for example, transmission through the Internet). The computer readable recording medium may also be distributed to computer devices connected by a network so that the computer readable codes are stored and executed in a distributed fashion.

In addition, unless defined otherwise in the detailed description, all the terms have the same meaning as meanings generally understood by those skilled in the art to which the present disclosure pertains. Generally used terms such as terms defined in a dictionary should be interpreted as the same meanings as meanings within a context of the related art and should not be interpreted as ideally or excessively formal meanings unless clearly defined in the present specification.

An exemplary embodiment of the present disclosure will now be described in detail with reference to accompanying drawings.

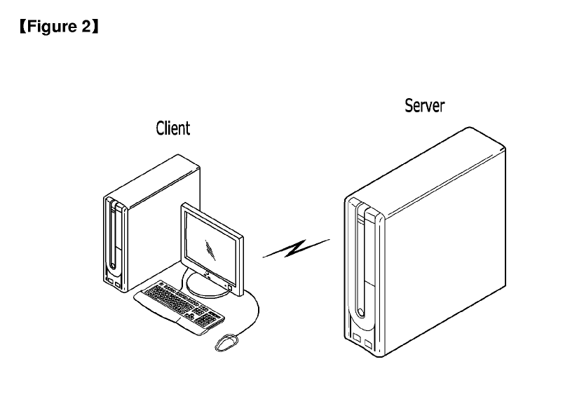

FIG. 2 is a diagram of a system providing an event service of a match result prediction according to a technique disclosed in the present disclosure. Referring to FIG. 2, a plurality of clients are connected to a server 1 and are updated with a game program or a game related patch, and the server 1 transmits data to the client requiring the patch etc.

In the present disclosure, the client is defined as being opposite to the server that is referred to as a computer supplying information, and users are defined as natural persons executing the operation of the client.

The server 1 activates a window capable of inserting prediction data to provide a response for the operation required by the client when a team that is predicted to win by the user operating the corresponding client only wins the online soccer game by identifying data and a program stored to the server 1.

If the user wants to change the prediction data, the user must again win the online soccer game, and since the corresponding prediction data may be changed after winning, the present disclosure is different from a gambling sports lottery that is unconditionally purchased if you have money, where the user may not participate in the match result predict event without their efforts such that the gambling is not encouraged.

That is, the lottery uses a ticket that is issued and sold for the purpose of specific projects issued in public institutions while accompanying prizes, but the match result predict event disclosed in the present disclosure induces attention to the real game, provides a presence and realism in conjunction with the actual game to overcome the limitations of the virtual online game, and the user must try to win the game for his team that is predicted in the online game to participate in the event, thereby obtaining the above-described effects without encouraging the gambling.

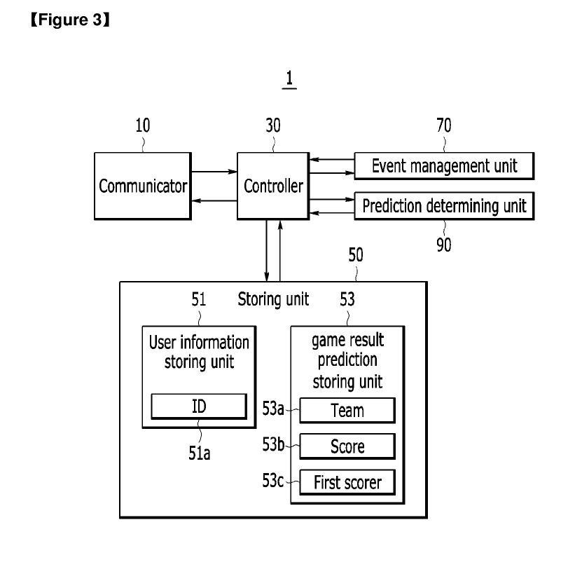

FIG. 3 is a block diagram of a server providing an event service of a match result prediction according to a technique disclosed in the present disclosure. Referring to FIG. 3, the server 1 providing the predict event service of the match result according to a technique disclosed in the present disclosure includes a communicator 10, a controller 30, a storing unit 50, an event management unit 70, and a prediction determination unit 90.

The communicator 10 is connected to a plurality of clients by a wire or wirelessly to receive an operation of a keyboard of each client and is configured to transmit/receive the data to be respectively suitable for a plurality of clients if the data of the prediction determination unit 90 determining whether to activate or de-activate a UI (user interface) generated in the event management unit 70 or the window to be predicted based on the data of the storing unit 50 is input.

The controller 30 is configured to respectively control the constituent elements and is an input/output passage of the data respectively output from the constituent elements. When the data output from a plurality of clients is input through the communicator 10, the controller 30 controls the data to be stored to the storing unit 50, and when performing the game through the operation and the control of the user operating a plurality of clients, the control 10 receives the operation of the client input through the communicator 10, and controls to output the UI output from the event management unit 70 and the prediction determination unit 90 and the data to be predicted to each client through the communicator 10.

The storing unit 50 includes a user information storing unit 51 and a match result predict storing unit 53, the user information storing unit 51 receives and stores a unique identification number such as an ID 51a to distinguish the use operating each client, and the match result predict storing unit 53 stores a team 53a predicted to win the game, a score 53b scored by the winning team, and a first scorer 53c.

That is, the team 53a is may be pointed out when the user participates in the event such that the team 53a is input to be linked and stored to the ID 51a, and since the score 53b obtained by the team predicted to win the game and the first scorer 53c generates an online team war environment in the server 1 and are windows that may be input if the uses win the game in the war environment, if the user wins with the predicted team, the corresponding data may be stored to the storing unit 50.

The event management unit 70 generates the corresponding UI to be suitable for the conditions, the prediction determination unit 90 may input the score 53b and the first scorer 53c only in the case the team that is thought to win actually wins the game in the online game, in the case of a lost game, it is returned to the step of performing the online game such that the user who has not won in the game may not participate in the event, such that all users can concentrate on the online game and the actual game.

That is, if the same online team war environment as at least one actual match is generated in the server 1, the server 1 receives the winning team prediction data of the actual match from the user, and when the user wins the game in the online team war environment to be suitable for the actual match winning team prediction data, the window capable of predicting at least one of the score 53b and the first scorer 53c of the actual match is activated in the prediction determination unit 90 of the server 1, and when at least one among the winning team prediction data, the score 53b, and the first scorer 53c accords with the result of the actual match, the corresponding reward is awarded.

This technique may be applied to a league as well as a 1:1 game, if the same online team war environment as the league of at least one group stage as the actual match is generated in the server 1,

the server 1 receives the winning team prediction data of the actual match from the user operating the client, when the user wins the game in the online team war environment to be suitable for the actual match winning team prediction data, the window predicting at least one of the score 53b of the actual match and the first scorer 53c, and a league ranking is activated in the prediction determination unit 90 of the server 1, when at least one among the winning team prediction data, the score 53b, the first scorer 53c, and the league ranking accords with the result of the actual league, and the corresponding reward is awarded.

This technique may be applied to a tournament game as well as the league game, and if the same online team war environment as at least one actual tournament is generated in the server 1, the server 1 receives at least one piece of prediction data of N finalists of the actual tournament and the winner from the user operating the client, while when the user wins the game according to the prediction data in the online team war environment and at least one among the prediction data accords with the result of the actual match, the corresponding reward is awarded.

During the event, when the user wants to change his predicted data, the data change is possible before the actual game starts, before a first score after the actual game starts, before a first half after the actual game starts, or before a second half if there is extra time after the actual game starts, and in the case of the league, the data change is possible when 1% to 80% of the league has been in progress.

Also, in the tournament or the league, if the score or the first scorer is not input, while performing the game by selecting the user's team expected to win, the result expected by the user for the league or the tournament may be created on their own.

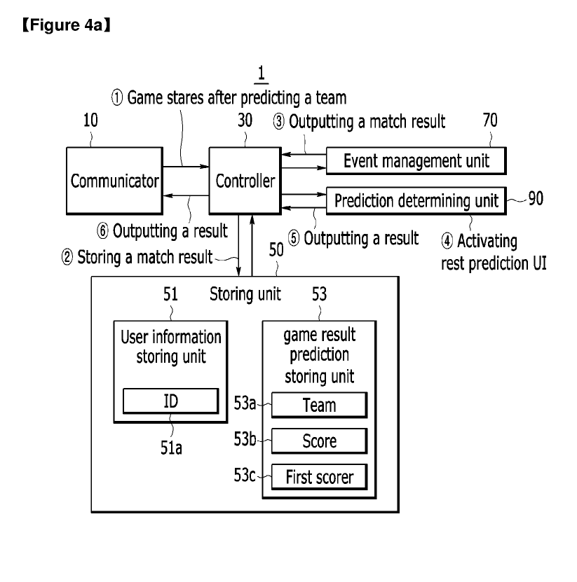

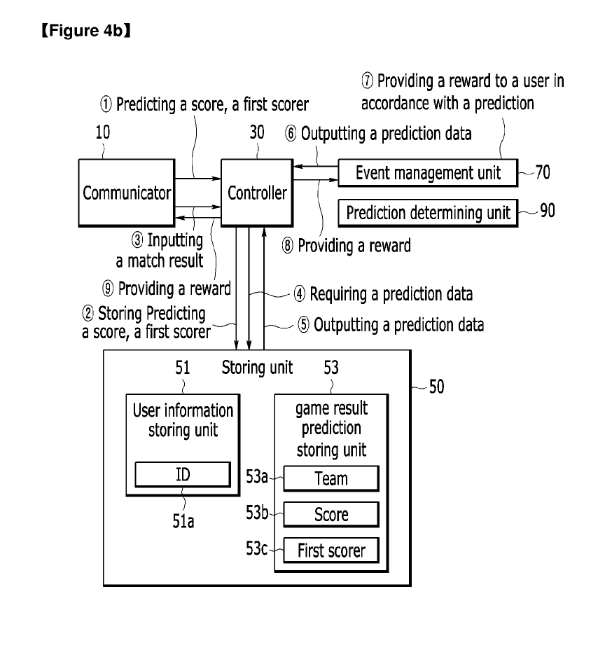

FIGS. 4A and 4B are block diagrams of a driving operation of a server providing an event service of a match result prediction according to a technique disclosed in the present disclosure. Referring to FIG. 4A, if the user starts the match after the team prediction, this result is stored to the storing unit 50, and is simultaneously output to the prediction determination unit 90, and when the user wins the game, the UI that may predict the remaining matches is activated, while in the lost game, the UI that may predict the remaining matches is not activated and the user is returned to the online game.

\textcircled{5} this result is output to the communicator 10 through the controller 30 \textcircled{6} and is transmitted to the client that is operated by the user.

Referring to FIG. 4B, when the user wins the game in the online game when the score 53b and the first scorer 3c are predicted \textcircled{1}, the controller 30 controls the storing unit 50 to store the result of predicting the score 53b and the first scorer 53c \textcircled{2}, if the actual match result is input through the communicator 10 \textcircled{3}, the controller 30 requires the prediction data to be stored to the storing unit 50 \textcircled{4}, if the prediction data is output to the event management unit 70 \textcircled{6} through the controller 30 \textcircled{5}, the event management unit 70 provides the corresponding reward to the user predicting the consistent data \textcircled{7}, and this reward providing data \textcircled{8} is transmitted to the client through control of the communicator 10 \textcircled{9}.

The present disclosure may be used for the event and may generate addictive content, and when selecting a team having a low winning rate such as a prototype or a Toto, game contents of a betting type may be manufactured with a method of providing the larger reward.

In the prediction event of the present disclosure, the same team war environment as the game that is actually scheduled is generated, the user selects the team expected to win and must win the game in the online game, if the user wins in the online game, the user may predict the other factors such as the score or the first scorer, and if the user wants to change his prediction before the event is finished, the user must again perform the match in the online game.

After the event is finished and the actual match has taken place, the reward is provided according to the prediction of the user, and in this case, odds of the reward are determined according to the winning rate of the team selected by the user, a single match, a multi-match, and the tournament result, and the group preliminary result of the league may be predicted, and the event may be simultaneously performed in plural.

With the concept of the technique disclosed in the present application being the same, the present disclosure is not limited to the described league or tournament, and it is apparent that various changes can be made.

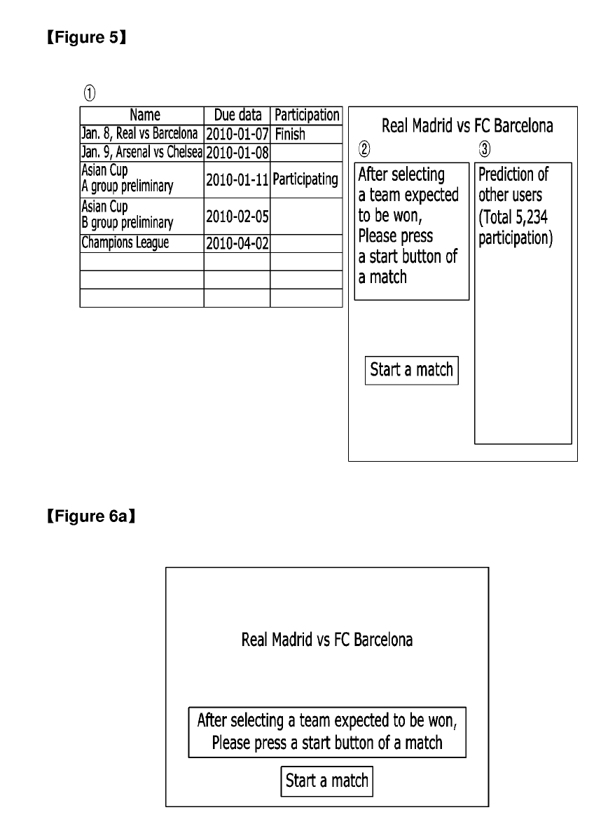

FIG. 5 shows a main screen of a prediction event service of a match result according to a technique disclosed in the present disclosure. Referring to FIG. 5, when the event is predetermined, an event menu is generated at an upper menu, and if the event menu is pressed, an event main screen appears.

If there is a plan to process many events in the event main screen, the event menu and the main screen may be separately manufactured, and in the corresponding screen, the ongoing event and the event in which the user participates, and the result of the event in which the user participates, are shown.

That is, is a list of the prediction events that are ongoing, the ongoing event list server is displayed through a setting of the server, and an event kind, a content, a period, attendance, etc. are displayed, for example, as in the following Table 1.

TABLE 1

| | | | |
|---|---|---|---|
| match result | Jan. 8, match result of | −2011.12.31 | Yunho's currently |
| prediction | Manchester United vs. | 24:00 | playing in |
| | Real Madrid | | |

\textcircled{2} is the selected event information, and shows the detailed information for the event selected in the event list and the UI to participate in the event, and \textcircled{3} is information related to the event and displays a prediction of others, participants, etc., as a reference for the user.

Here, if the user selects the predicted team to be won and pushes a game start, the game may start only if the corresponding team must win the game in the online game, and since the score to participate in its events and the first scorer etc. may be input, in order to participate in that event, the user must make the team predicted to win to unconditionally win in the online game.

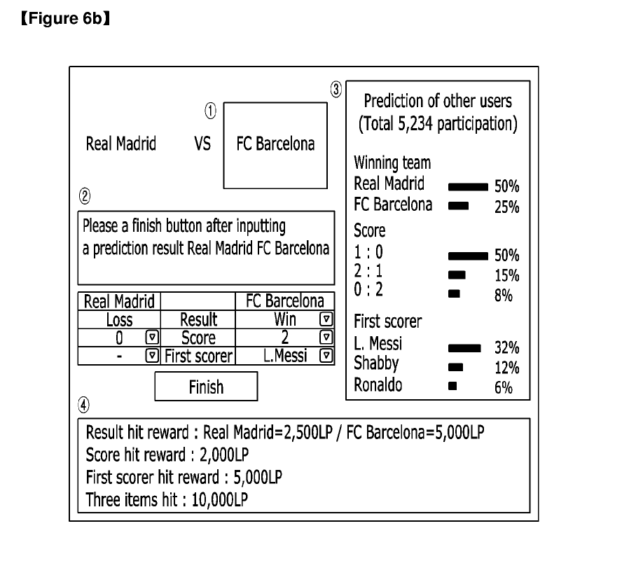

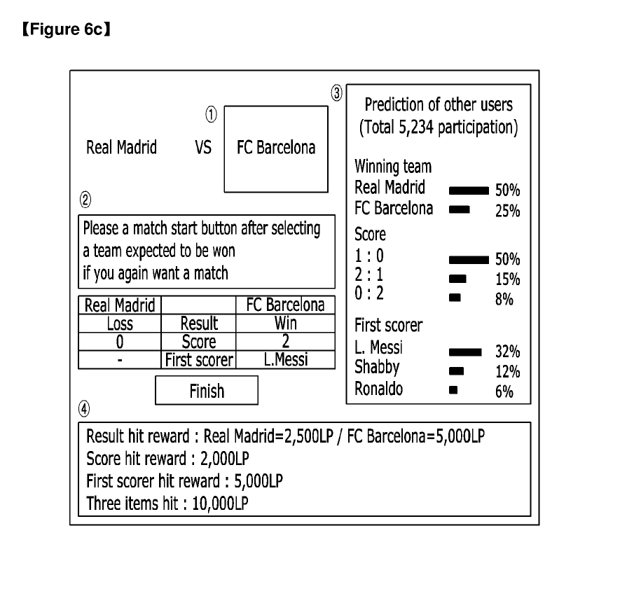

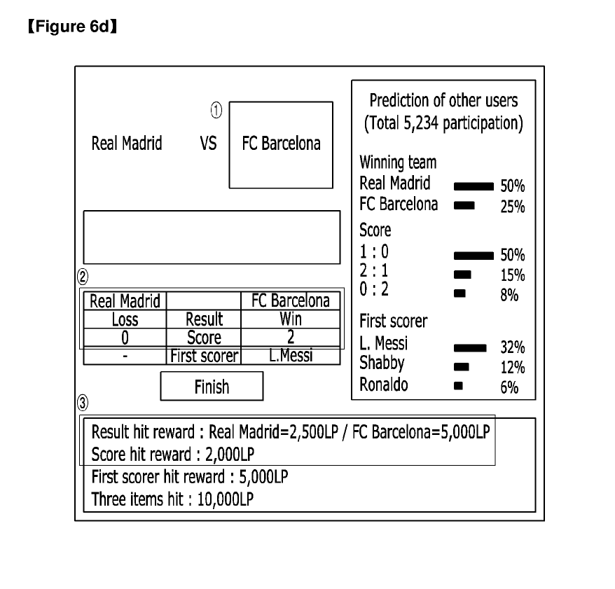

FIGS. 6A, 6B, 6C, and 6D show screens of a progress process of an event service of a match result prediction according to a technique disclosed in the present disclosure. FIGS. 6A, 6B, 6C, and 6D describe a single match result predict service as an exemplary embodiment, and referring to FIG. 6A, in the single match result predict service, the match result of two teams is predicted, and when setting the event of this kind, after the user selects the team expected to win among two teams, the user may participate in the event if the user actually needs to win.

For example, if an FC Barcelona vs. Real Madrid game is set as the event, and the user predicts that FC Barcelona will win the game, on the online game, FC Barcelona is selected such that FC Barcelona must beat Real Madrid in the online game.

Next, the user selects the score, the first scorer, etc. to participate in the event, the user may change his prediction before finishing the event, and the user must win the game in progress for each game. If a team having a low winning rate, that is, a team having a low selection of the user is selected, if the team having the low winning rate wins the game, the reward that can be obtained increases, and the reward may be changed from time to time according to the winning rate.

Referring to FIG. 6B, which is a screen after the event participation, that is, when the user's team wins the game in the online game, \textcircled{1} shows the user's team selected to win, \textcircled{2} is the window to input the score, the first scorer is activated, and \textcircled{3} may show the expectation of other users.

If the user wins the game through the user's team in the online game, the user may predict the score and other items, while if the user is defeat, the game starts while the screen before the event participation is displayed.

If a finish button is pressed, the prediction of the user is stored, only the team selected by the user and the win/loss of the game are stored before the user presses the finish button, and in this state, if the finish button is not pressed and the client is finished, if the access is again gained, the user again shows the state that the prediction is not stored, that is, the screen of FIG. 6B.

Referring to FIG. 6C, the screen after the prediction finish is shown, where is the user's team selected to win, and may confirm that in the window to input the score, the first scorer is not activated.

If the data, the score, the first scorer predicted by the user are set and the finish is pressed, they are stored to the storing unit, and if the user wants to change the predetermined prediction, the online game must be restarted.

Referring to FIG. 6D, after the game is over, the result hits among the predictions of the user are displayed, and for example, the expected and hit items and the reward provided to the user may be highlighted.

Here, when displaying the result, \textcircled{1} that his chosen team wins is highlighted by a red border etc. to be recognized, \textcircled{2} his matched score is displayed by the red border and his first scorer that is not matched is not highlighted by a method of maintaining the original, and \textcircled{3} the reward for his hit result is only highlighted by the red color or the border for the reward. As long as it is highlighted and is displayed to be recognized by the user without a limitation of the color or the design, many forms are possible.

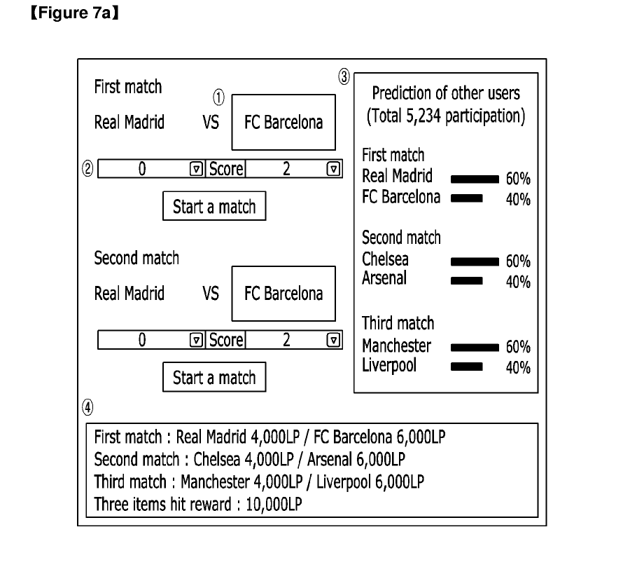

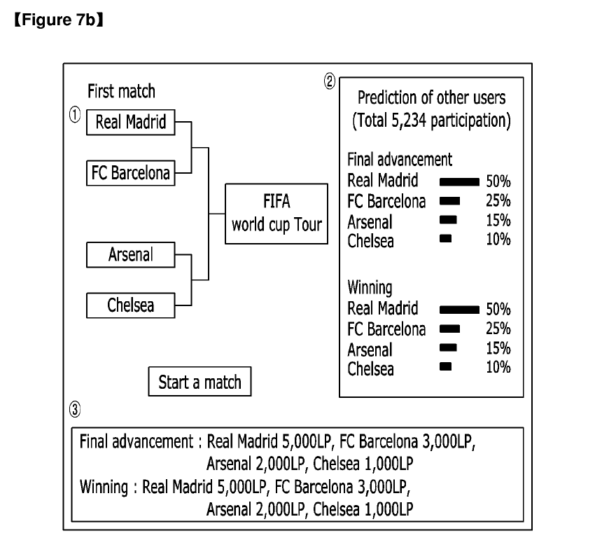

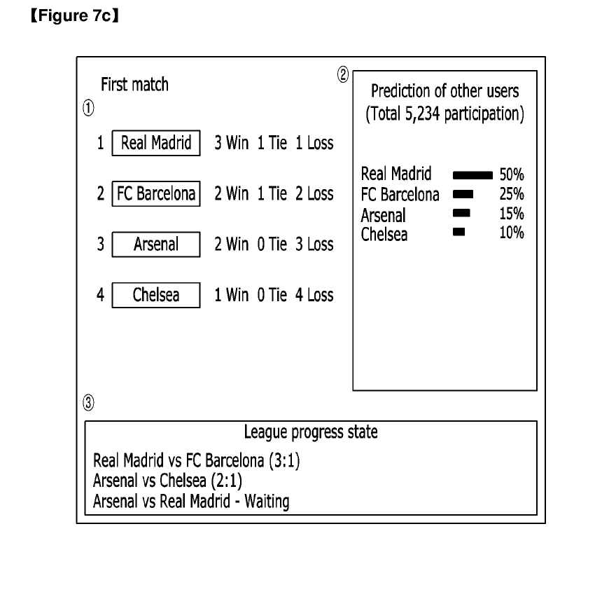

FIGS. 7A, 7B, and 7C show an exemplary embodiment applied with an event service of a match result prediction according to a technique disclosed in the present disclosure. Referring to FIG. 7A, it is possible to predict a plurality of match results, and in the prediction of a plurality of match results, when predicting the win/loss or the first scorer for a plurality of match results, \textcircled{1} is his team selected to be won, \textcircled{2} is the window to input the score, the first scorer is activated, may show the predictions of other users, and displays the rewards when the user corrects the result.

After selecting the team expected to win, the match proceeds, and it is possible to set the score in the winning case like the single match. Overlapping description is omitted.

Referring to FIG. 7B, it is possible to predict the tournament, and in the tournament prediction, as the tournament result, that is, for a round of N teams, the winning team is predicted, \textcircled{1} is his team selected to win, \textcircled{2} is the prediction of other users, and \textcircled{3} displays the rewards when the user hits the results.

After selecting the team expected to win, the match proceeded and the expected tournament result is determined, and the following process is the same as for the single match such that overlapping description is omitted.

Referring to FIG. 7C, it is possible to predict the league results as the group stage prediction, there is a prediction event for predicting the rankings and the records while the group preliminaries proceed, the league match progresses according to the schedule like the league play, the user proceeds with the match by selecting the user's team to win for each match, and the match result of the user may be set as the prediction result as it is.

\textcircled{1} is the user's team selected to win, \textcircled{2} is the predictions of other users, and \textcircled{3} displays the league progression state.

That is, after selecting the team expected to win, the match proceeds, the score is not set if the user wins the game, but the user's predicted score must be directly made in the online game after selecting the predicted team, and even if it is not done this manner, the prediction services can be configured in a variety of ways.

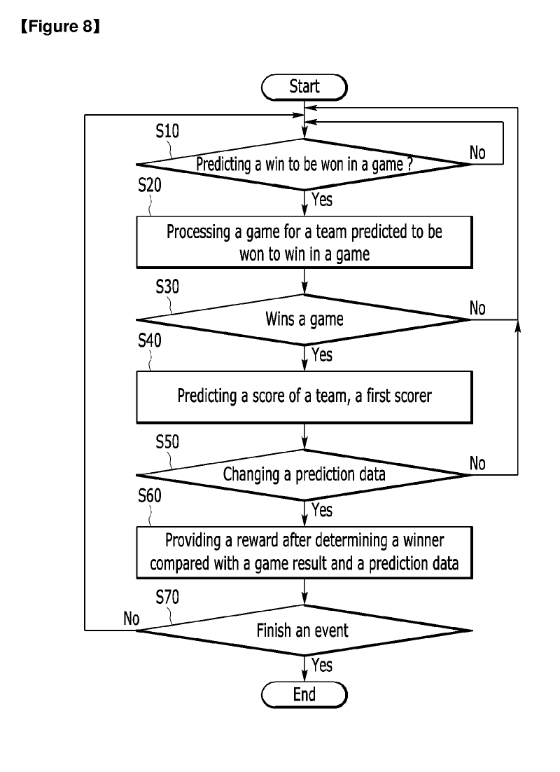

FIG. 8 is a flowchart showing a method of providing an event service of a match result prediction according to a technique disclosed in the present disclosure. As shown in FIG. 8, if the user inputs the team to win in the actual match through the client to be input to the server S10, the server proceeds with the game by the team expected to win and the user proceeds with the game for the predicted team to win the game in the online game S20, the score of the team and the first scorer may be predicted in the case S30 of winning the game S40, and in the case that the prediction data is changed S50, the user may again return to the step S10 and the team may be changed, or the user may again return to the step S20, and the score and the first scorer may only be changed.

The reward is provided after determining the winner by comparing the corresponding actual match result and the prediction data S60, and the user returns to the step S10 before the corresponding event is finished and circles the circulation loop S70.

In the present method, repeated description is omitted.

The method for providing the event service of a match result prediction according to an exemplary embodiment of the present disclosure as described above may be executed by applications basically installed in the terminal (including programs included in a platform, an operating system, or the like which are basically installed in the terminal), and may also be executed by the applications (i.e., programs) which are directly installed in the terminal by the user via an application store server or a web server associated with the applications or the corresponding services.

The method for the providing the event service of a match result prediction according to an exemplary embodiment of the present disclosure as described above may be implemented by the applications (i.e., programs) which are basically installed or directly installed by the user in the terminal, and may be recorded in a computer readable recording medium of the terminal and the like.

A program realizing the method providing the predict event service of the match result of the present disclosure in a recording media recorded with the program to execute the method providing the predict event service of the match result realizes a function of generating the same online team war environment as at least one actual match in the server; a function of receiving the winning team prediction data of the actual match from the user operating the client by the server; a function of activating the window to predict at least one among the score and the first scorer of the actual match in the server when the user wins in the online team war environment in accordance with the winning team prediction data; and a function of providing the corresponding reward when the result of the actual match is in accordance with the winning team prediction data, the score, or the first scorer.

The programs are recorded in the computer readable recording medium and are executed by the computer, such that the above-mentioned functions may be executed.

As described above, in order for the computer to read the programs recorded in the recording medium and execute the method for the providing the item collection event according to an exemplary embodiment of the present disclosure, the above-mentioned programs may include codes which are coded with computer languages such as C, C++, JAVA, machine language, and the like which may be read by a processor (CPU) of the computer.

The code may include a function code associated with a function of defining the above-mentioned functions, and may also include an execution procedure related control code required for the processor of the computer to execute the above-mentioned functions according to a predetermined procedure.

Further, the code may include a memory reference related code indicating at which location (address number) of the memory inside or outside the computer additional information or media required for the processor of the computer to execute the above-mentioned functions needs to be referenced.

In addition, in order for the processor of the computer to execute the above-mentioned functions, when the processor needs to communicate with any other computers or servers, etc. at a remote location, the code may further include a communication related code regarding how the processor of the computer communicates with any other computers or servers at a remote location or which information or media the processor of the computer transmits and receives at the time of the communication, by using the communication module (for example, a wired and/or wireless communication module) of the computer.

Further, a functional program for implementing the present disclosure, a code and a code segment associated therewith, and the like may be easily inferred or changed by programmers in the art to which the present disclosure pertains in consideration of a system environment of the computer which reads the recording medium and executes the program.

Hereinabove, examples of a computer readable recording medium recorded with programs as described above include a ROM, a RAM, a CD-ROM, a magnetic tape, a floppy disk, an optical media storage device, and the like.

Further, a computer readable recording medium recorded with programs as described above may be distributed to a computer system connected through a network and thus store and execute a computer readable code by a distributed manner. In this case, at least one computer among a plurality of distributed computers may execute a part of the above-mentioned functions and transmit the executed results to at least one of the other distributed computers, and the computer receiving the result may also execute a part of the above-mentioned functions and provide the executed results to the other distributed computers.

In particular, a computer readable recording medium recorded with applications, which are programs for executing the method for providing the predict event service of the match result in accordance with the exemplary embodiments of the present disclosure, may be a storage medium (for example, a hard disk and the like) included in an application store server or an application providing server such as a web server associated with applications or corresponding services, and the like, or the application providing server itself.

A computer, which may read a recording medium recorded with applications that are programs for executing the method for providing the predict event service of the match result in accordance with the exemplary embodiments of the present disclosure, may include not only a general PC such as a typical desktop and a laptop, but also a mobile terminal such as a smart phone, a tablet PC, a personal digital assistant (PDA), and a mobile communication terminal, and is to be construed as all the computable devices.

When a computer, which may read a recording medium recorded with applications that are programs for executing the method for providing the predict event service of the match result in accordance with the exemplary embodiments of the present disclosure, is a mobile terminal such as a smart phone, a tablet PC, a personal digital assistant (PDA), and a mobile communication terminal, the applications are downloaded from an application providing server to a general PC and thus may also be installed in the mobile terminal through a synchronization program.

The exemplary embodiments of the present disclosure may be realized in a program instruction format executable by various computer means and may be recorded on a computer readable medium. The computer readable medium may include a program instruction, file data, and data structures, or combinations thereof. The program instruction recorded on the medium may be those that are designed and configured for the present disclosure, or those that are known to a person of ordinary skill in the art of computer software and are usable. Examples of the computer readable medium include magnetic media such as a hard disk drive, a floppy disk, or a magnetic tape, optical media such as a CD-ROM or a DVD, magneto-optical media such as a floptical disk, and a hardware device specially configured to store and execute program instructions such as a ROM, a RAM, or a flash memory. Examples of the program instruction include high-level language codes executable by a computer by using an interpreter in addition to machine language codes generated by a compiler. The hardware device can be configured to be operable as at least one software module for performing an operation of the present disclosure.

The present disclosure \textcircled{1} may maximize the fun of the actual game and the online game by making the same match team as an actual match in an online game and participating in an event in a case that the users must win the match through the team that is directly selected by the user in the online game to predict their match result, thereby helping game participation of the users and together making the prediction result without only waiting for the prediction result, \textcircled{2} may further concentrate on the online game due to factors like the player of the real game and may feel realism such as running the actual game in the virtual online game while linking of the online game and the actual match by inserting the content for the actual match prediction in the online game, \textcircled{3} may maximize the interest factor like the real game in the virtual online game by grafting the online game to the real game without encouraging gambling since the users participate in the event in the case that the team that is predicted to win by them in the game must win by their effort, rather than as a vague probability game like a gambling lottery, \textcircled{4} may create a new revenue structure by deriving a purchase of the same item and may increase richness of the item with prediction assistance contents helping determining of the user by consuming a point, a game currency, or a cache item when participating in the event, and may attract the interest of the users who do not have interest in the small competition and may simultaneously act as a means to promote the competition by deriving interest in the real game such as the K League, a World Cup, and Asian Games.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

1. A method for providing an event service of a match result prediction, comprising:
a first step of generating the same online game as at least one actual match in a server;
a second step of receiving winning team prediction data of the actual match from a user operation of a client by the server;
a third step of activating a window to predict and input at least one among a score of the actual match and a first scorer in the server when the user wins in the online game in accordance with the winning team prediction data; and
a fourth step of inputting at least one of the score of the actual match and the first scorer to the server and executing a reward providing odds determined according to a winning probability of a team selected by the user when the result of the actual match is in accordance with one of the winning team prediction data, the score, and the first scorer.

2. The method of claim 1, wherein
the first step further includes a step of generating the same online game as a league as the actual match of at least one group stage; and
the third step further includes a step of activating to predict and input at least one of the score of the actual match, the first scorer, and a league ranking.

3. The method of claim 1, wherein:
the first step further includes a step of generating the same online game as at least one real tournament; and
the second step further includes a step of receiving at least one piece of prediction data among N final lists of the actual tournament and a winning team from the user.

4. The method of claim 1, wherein, in the third step,
if the user executes control to change the winning team prediction data, the server is returned to the second step.

5. The method of claim 1, wherein, in the third step,
if the user executes control to change the data predicting at least one of the score and the first scorer of the actual match, the server activates the online game.

6. The method of claim 2, wherein, in the third step,
if the user executes control to change the data predicting at least one of the score, the first scorer, and the league ranking of the actual match, the server activates the online game.

7. The method of claim 1, wherein, for the reward,
odds are determined such that a reward is small if the selected team wins a lot and the reward is large if the selected team wins less.

8. The method of claim 1, wherein, for the second step,
the server provides a prediction event list that is ongoing, event information selected by the prediction of the user, and information related to the prediction event.

9. The method of claim 8, wherein the information related to the predict event
includes at least one of prediction data predicted by other users who participated in the event.

10. The method of claim 1, wherein, in the third step,
it is possible for the user to change the prediction data before the actual match starts, before a first score after the actual game starts, before a first half after the actual game starts, or before a second half when there is extra time after the actual game starts.

11. The method of claim 10, wherein
the data change is possible when 1% to 80% of the league has proceeded.

12. The method of claim 1, wherein, in the fourth step,
the prediction of the user is not input, and the result in the online game is in accordance with at least one of the score of the actual match, the first scorer, and the winning team prediction data.

13. A computer readable recording medium recorded with a program to execute a method for providing a prediction event service of a match result,
wherein the method for providing the predict event service of the match result includes: a function of generating the same online game as at least one actual match in a server;
a function of receiving winning team prediction data of the actual match from the user operation of a client through the server;
a function of activating a window to predict and input at least one of the score of the actual match and the first scorer in the server when the user wins in accordance with the winning team prediction data in the online game; and
a function of receiving at least one of the score of the actual match and the first scorer through the server and executing a reward providing odds determined according to a winning probability of the team selected by the user, wherein the result of the actual match is in accordance with at least one of the winning team prediction data, the score, and the first scorer.

14. A server providing an event service of a match result prediction, comprising:
a communicator transmitting and receiving data;
a controller respectively controlling constituent elements;
a storing unit storing at least one of a winning team of at least one actual match, a ranking, N teams finalists, a winning team if the client inputs at least one of the winning team of at least one actual match, the ranking, the N teams finalists, and the winning team, and receiving and storing the score of the actual match of the user and a first scorer when the user operating the client wins in the online game;
a prediction determination unit activating a window to input the score of the actual match and the first scorer when the user wins in the online game for the user operating the client to input the score of the actual match and the first scorer;
an event management unit generating a window to input game prediction data by the client and a user interface (UI) related to the game prediction data; and
a controller controlling the communicator, the storing unit, the prediction determination unit, and the event management unit.
